(19) United States
(12) Patent Application Publication
(10) Pub. No.: US 2022/0160034 A1
(43) Pub. Date: May 26, 2022

(54) ATOMIZATION DEVICE AND ELECTRONIC CIGARETTE

(71) Applicant: SHENZHEN SINOVA TECHNOLOGY CO., LTD., Shenzhen (CN)

(72) Inventor: Jingming Chen, Shenzhen (CN)

(21) Appl. No.: 16/953,339

(22) Filed: Nov. 20, 2020

(51) Int. Cl. A24F 40/42; A24F 40/10; A24F 40/48

(52) U.S. Cl. CPC A24F 40/42; H05B 1/0244; A24F 40/48; A24F 40/10

(57) ABSTRACT

The present disclosure provides an atomization device and an electronic cigarette. The atomization device includes a fluid tank, an atomization assembly arranged in the fluid tank, a first cover plate including first air inlet holes, and a second cover plate including second air inlet holes. The first air inlet holes are arranged along a first direction. The second air inlet holes are arranged along a second direction. The second cover plate is arranged on a bottom portion of the fluid tank. The second cover plate is connected with the first cover plate. The second cover plate is arranged between the fluid tank and the first cover plate. The first direction is different with the second direction. The first air inlet holes are configured to transmit gas to the second air inlet holes. The second air inlet holes are configured to transmit the gas into the fluid tank.

### TECHNICAL HELD

The present disclosure relates to a field of electronic cigarette technology, and in particular to an atomization device and an electronic cigarette.

### BACKGROUND

An electronic cigarette is an electronic product that imitates a cigarette, and generally comprises a cigarette holder, an atomizer, and battery components. When the atomizer of the electronic cigarette is working, it heats e-liquid installed in the atomizer to make it atomized for smoking by a user.

In the prior art, the atomizer generally comprises an air inlet hole and an air outlet hole on a middle portion of two ends of the atomizer to realize gas circulation. A vent hole is communicated with the cigarette holder for the user to smoke the gas atomized by the atomizer, However, the design of the air inlet hole and the air outlet hole of the atomizer makes the gas to be transmitted too fast, which in turn causes the user to feel less comfortable in smoking the atomized gas.

### SUMMARY

The present disclosure provides an atomization device and an electronic cigarette to slow down a transmission speed of gas.

The present disclosure provides an atomization device. The atomization device comprises a fluid tank, an atomization assembly arranged in the fluid tank, a first cover plate, and a second cover plate. The first cover plate comprises at least two first air inlet holes. The at least two first air inlet holes are arranged along a first direction. The second cover plate comprises at least two second air inlet holes. The at least two second air inlet holes are arranged along a second direction. The second cover plate is arranged on a bottom portion of the fluid tank. The second cover plate is connected with the first cover plate. The second cover plate is arranged between the fluid tank and the first cover plate. The first direction is different with the second direction. The at least two first air inlet holes are configured to transmit gas to the at least two second air inlet holes. The at least two second air inlet holes are configured to transmit the gas into the fluid tank.

The present disclosure provides an electronic cigarette. The electronic cigarette comprises the atomization device.

In the present disclosure, an arrangement direction of the at least two first air inlet holes of the first cover plate is different with an arrangement direction of the at least two second air inlet holes of the second cover plate, so that when gas enters the at least two second air inlet holes of the second cover plate from the at least two first air inlet holes of the first cover plate, a transmission direction of the gas changes. Thus, the present disclosure reduces a transmission speed of the gas, which makes the gas atomized by the atomization device that being smoked by a user dense, and improves the comfort of the user during smoking the gas atomized by the atomization device.

### BRIEF DESCRIPTION OF DRAWINGS

In order to clearly describe the technical solutions in the embodiments of the present disclosure, the following will briefly introduce the drawings required for the description of the embodiments. Obviously, the drawings in the following description are only some embodiments of the present disclosure. For those skilled in the art, other drawings can be obtained based on these drawings without creative work.

In order to have a complete understanding of the present disclosure, the following description will be made with reference to the accompanying drawings, in which the same reference numerals in the following description represent the same portions.

FIG. 1 is a side view of an atomization device according to one embodiment of the present disclosure.

FIG. 2 is a cross-sectional view taken along the line P1-P1 shown in FIG. 1 of the atomization device of the present disclosure.

FIG. 3 is a front view of the atomization device according to one embodiment of the present disclosure.

FIG. 4 is a cross-sectional view taken along the line P2-P2 shown in FIG. 3 of the atomization device of the present disclosure.

FIG. 5 is a perspective view of the atomization device according to one embodiment of the present disclosure.

FIG. 6 is an exploded view of the atomization device according to one embodiment of the present disclosure.

FIG. 7 is a schematic diagram of portions of a structure of the atomization device according to one embodiment of the present disclosure.

FIG. 8 is an exploded view of portions of an electronic cigarette according to one embodiment of the present disclosure.

FIG. 9 is a schematic diagram of a cigarette holder of the electronic cigarette shown in FIG. 8.

### DETAILED DESCRIPTION

Technical solutions in the embodiments of the present disclosure will be described clearly and completely in combination with the drawings in the embodiments of the present disclosure. Obviously, the described embodiments are only a part of the embodiments of the present disclosure, rather than all the embodiments. Based on the embodiments in the present disclosure, all other embodiments obtained by those skilled in the art without creative work shall fall within the protection scope of the present disclosure.

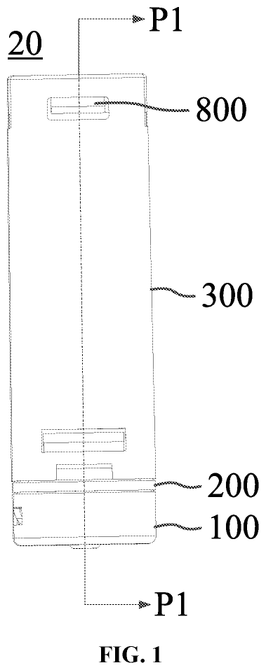

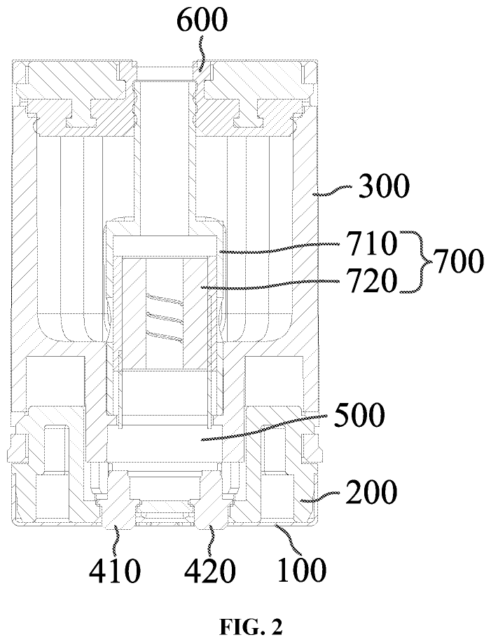

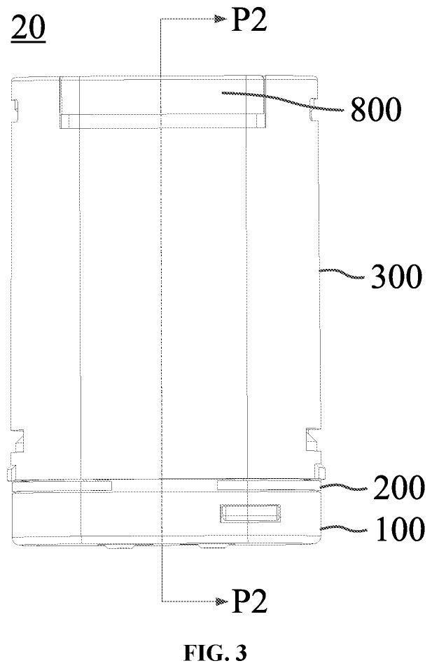

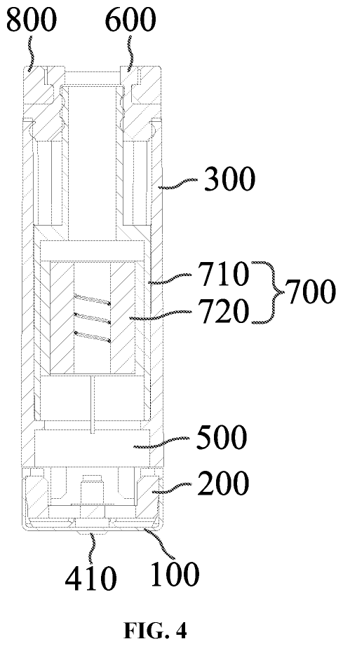

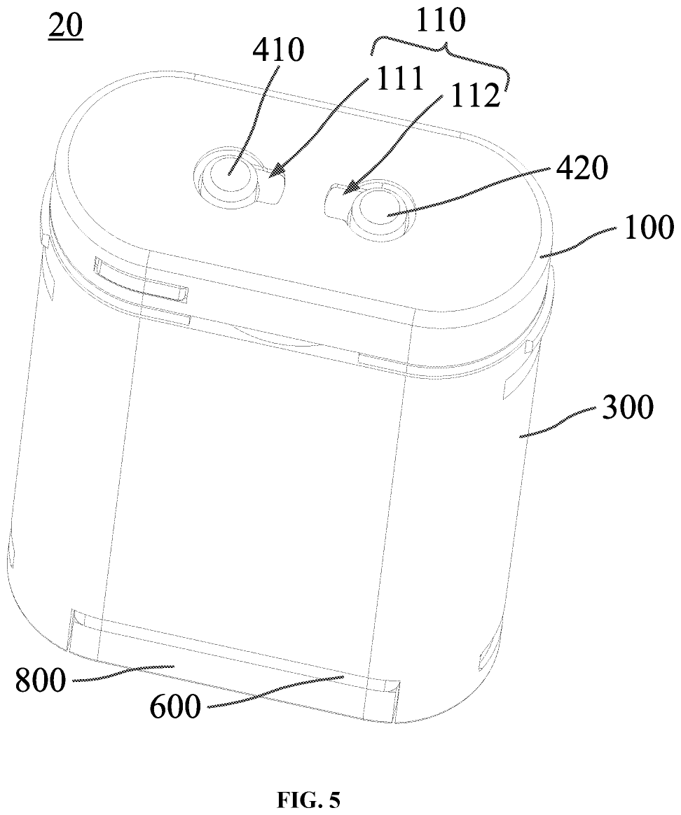

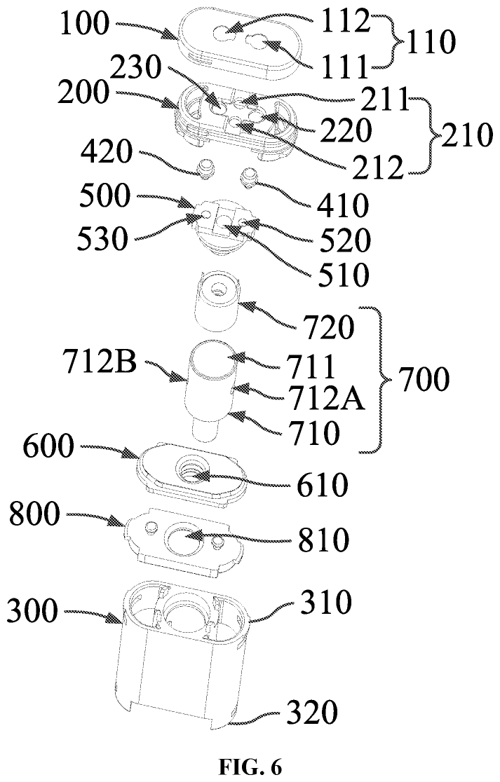

As shown in FIGS. 1-6, FIG. 1 is a side view of an anatomization device according to one embodiment of the present disclosure. FIG. 2 is a cross-sectional view taken along the line P1-P1 shown in FIG. 1 of the anatomization device of the present disclosure. FIG. 3 is a front view of the anatomization device according to one embodiment of the present disclosure. FIG. 4 is a cross-sectional view taken along the line P2-P2 shown in FIG. 3 of the anatomization device of the present disclosure. FIG. 5 is a perspective view of the anatomization device according to one embodiment of the present disclosure. FIG. 6 is an exploded view of the anatomization device according to one embodiment of the present disclosure.

The atomization device 20 comprises an air inlet structure for transmitting gas. For example, at least two first air inlet holes 110 arranged along a first direction and at least two second air inlet holes 210 arranged along a second direction are on one end of the atomization device 20. The at least two first air inlet holes 110 are configured to transmit gas to the at least two second air inlet holes 210. The first direction is different with the second direction. When the gas enters the at least two second air inlet holes 210 from the at least two first air inlet holes 110, a transmission path of the gas changes. Thus, the present disclosure reduces a transmission speed of the gas, which makes the gas atomized by the atomization device that is being smoked by a user dense, and improves the comfort of the user during smoking the gas atomized by the atomization device.

An included angle between the first direction and the second direction is not less than 30 degrees and no more than 150 degrees. It should be noted that in order to improve the comfort of the user during smoking, in one embodiment, the included angle between the first direction and the second direction is not less than 60 degrees and no more than 120 degrees. For example, the included angle between the first direction and the second direction is 90 degrees, that is, the first direction and the second direction are perpendicular to each other. In the following embodiments, the first direction and the second direction are perpendicular to each other, for example.

The first direction is a width direction of the atomization device 20. The second direction is a thickness direction of the atomization device 20. The width of the atomization device 20 is greater than the thickness of the atomization device 20, so that the at least two first air inlet holes 110 are arranged along the width direction of the atomization device 20, and the at least two second air inlet holes 210 are arranged along the thickness direction of the atomization device 20.

It should be noted that if an arrangement distance of the at least two first air inlet holes 110 and the at least two second air inlet holes 210 is too large, the transmission speed of the gas transmitted from the at least two first air inlet holes 110 to the at least two second air inlet holes is too slow, which will affect the comfort of the user during smoking the gas atomized by the atomizing device. Based on this, in the embodiment of the present disclosure, the second air inlet holes 210 are arranged between each two first air inlet holes 110 of all the first air inlet holes 110.

In some embodiments, the at least two first air inlet holes 110 comprise a first sub air inlet hole 111 and a second sub air inlet hole 112. The first sub air inlet hole 111 and the second sub air inlet hole 112 are arranged along the width direction of the atomization device 20. the at least two second air inlet holes 210 are arranged along the thickness direction of the atomization device 20. The at least two second air inlet holes 210 comprise a third sub air inlet hole 211 and a fourth sub air inlet hole 212. The third sub air inlet hole 211 and the fourth sub air inlet hole 212 are arranged along the thickness direction of the atomization device 20. Thus, in the embodiment of the present disclosure, the first sub air inlet hole 111 and the second sub air inlet hole 112 transmit the gas to the third sub air inlet hole 211 and the fourth sub air inlet hole 212 to form a cross-shaped structure of gas transmission path. The cross-shaped structure of gas transmission path in the embodiment of the present disclosure makes the gas denser and makes the user feel comfortable, and the uses has a better experience.

As shown in FIGS. 1-6. the atomization device 20 comprises a first cover plate 100, a second cover plate 200, a fluid tank 300, and an atomization assembly 700.

The fluid tank 300 accommodates the atomization assembly 700 and is configured to store c-liquid. The fluid tank 300 comprises two ends, such as a top portion 320 and a bottom portion 310, The top portion 320 of the fluid tank is one end of the fluid tank 300 where air is discharged, and the bottom portion 320 of the fluid tank is one end of the fluid tank 300 where air is input.

The first cover plate 100 and the second cover plate 200 are arranged on the bottom portion 310 of the fluid tank 300. The second cover plate 200 is arranged between the first cover plate 100 and the fluid tank 300. The first cover plate 100 is a bottom cover of the atomization device 20.

In the embodiment, at least two first air inlet holes 110, such as the first sub air inlet hole 111 and the second sub air inlet hole 112, are formed on the first cover plate 100. The first sub air inlet hole 111 and the second sub air inlet hole 112 penetrate the first cover plate 100 in a thickness direction of the first cover plate 100. That is, the first cover plate 100 comprises at least two first air inlet holes 110, such as the first sub air inlet hole 111 and the second sub air inlet hole 112.

In the embodiment, at least two second air inlet holes 210, such as the third sub air inlet hole 211 and the fourth sub air inlet hole 212, are formed on the second cover plate 200. The third sub air inlet hole 211 and the fourth sub air inlet hole 212 penetrate the second cover plate 200 in a thickness direction of the second cover plate 200. That is, the second cover plate 200 comprises at least two second air inlet holes 210, such as the third sub air inlet hole 211 and the fourth sub air inlet hole 212.

The embodiment of the present disclosure takes the at least two first air inlet holes 110 on the first cover plate 100 as the first sub air inlet hole 111 and the second sub air inlet hole 112, and takes the at least two second air inlet holes 210 on the second cover plate 200 as the third sub air inlet hole 211 and the fourth sub air inlet hole 212 as examples for description.

The first sub air inlet hole 111 and the second sub air inlet hole 112 transmit the gas outside the first cover plate 100 into a space between the first cover plate 100 and the second cover plate 200, and then the gas transmission path is generated changed to make the gas transmit to the third sub air inlet hole 211 and the fourth sub air inlet hole 212 of the second cover 200. In the prior art, corresponding air inlets holes are on the first cover plate and the second cover plate. Compared with the prior art, the embodiment of the present disclosure slows down a transmission time of the gas from the first sub air inlet hole 111 and the second sub air inlet hole 112 to the third sub air inlet hole 211 and the fourth sub air inlet hole 212 to reduce a speed of the gas transmitted from the first sub air inlet hole 111 and the second sub air inlet hole112 to the third sub air inlet hole 211 and the fourth sub air inlet hole 212. The third sub air inlet hole 211 and the fourth sub air inlet hole 212 transmit the gas to the fluid tank 300.

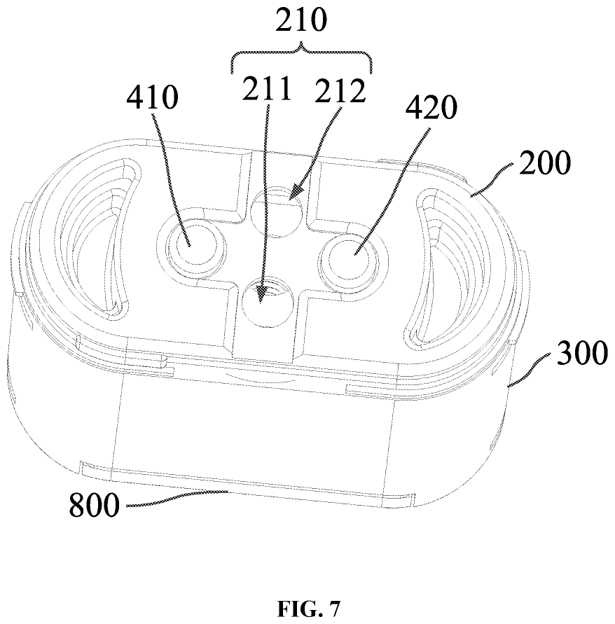

As shown in FIG. 7, FIG. 7 is a schematic diagram of portions of a structure of the atomization device according to one embodiment of the present disclosure. And as it shown in FIGS. 1-6, the second cover plate 200 comprises a first mounting hole 220 and a second mounting hole 230. The first mounting hole 220 and the second mounting hole 230 are arranged in a same direction as the first sub air inlet hole 111 and the second sub air inlet hole 112. In addition, the first mounting hole 220 corresponds to the first sub air inlet hole 111, and the second mounting hole 230 corresponds to the second sub air inlet hole 112.

The atomization device 20 further comprises a first thimble 410 and a second thimble 420. A portion of the first thimble 410 is arranged in the first mounting hole 220 and another portion of the first thimble 410 is arranged in the first sub air inlet hole 111. A size of the first sub air inlet hole 111 is greater than a size of the portion of the first thimble 410 arranged in the first sub air inlet hole 111. Thus, it is ensured that the gas enters the space between the first cover plate 100 and the second cover plate 200 through the first sub sir inlet hole 111. Another portion of the first thimble 410 protrudes from the first sub sir inlet hole 111 to an outside of the first cover plate 100 to realize the connection with other components such as a battery. The first thimble 410 is connected with the atomization assembly 700.

A portion of the second thimble 420 is arranged in the second mounting hole 230. another portion of the second thimble 420 is arranged in the second sub air inlet hole 112. A size of the second sub air inlet hole 112 is greater than a size of the portion of the second thimble 420 arranged in the second sub air inlet hole 112. Another portion of the second thimble 420 protrudes from the second sub sir inlet hole 112 to an outside of the first cover plate 100 to realize the connection with other components such as the battery. The second thimble 420 is connected with the atomization assembly 700.

The bottom portion 310 of the fluid tank 300 may be equipped with sonic sealing structures to achieve sealing of the bottom portion 310 of the fluid tank 300. As shown in FIGS. 1-6, the atomization device 20 further comprises a first sealing plug 500 arranged on the bottom portion 310 of the fluid tank 300. The first sealing plug 500 is configured to seal the bottom portion 310 of the fluid tank 300. The first sealing plug 500 is arranged between the fluid tank 300 and the second cover plate 200. The first sealing plug 500 comprises a third air inlet hole 510. The third air inlet hole 510 is communicated with the at least two second air inlet holes 210 (such as the third sub air inlet hole 211 and the fourth sub air inlet hole 212). The gas from the third sub air inlet hole 211 and the fourth sub air inlet hole 212 is transmitted to the third gas inlet hole 510, and then the gas is transmitted to an inside of the fluid tank 300 through the third air inlet hole 510.

The first sealing plug 500 comprises a first through hole 520 and a second through hole 530. The first through hole 520 receives the first thimble 410, and the second through hole 530 receives the second thimble 420, Thus, the first thimble 410 is connected with the atomization assembly 700 arranged in the fluid tank 300 through the first through hole 520. The second thimble 420 is connected with the atomization assembly 700 arranged in the fluid tank 300 through the second through hole 530.

As shown in FIGS. 1-6, the atomization assembly 700 comprises a vent pipe 710 and an atomization core 720. The vent pipe 710 comprises an air passage 711 communicated with the third air inlet hole 510. The vent pipe 710 comprises a plurality of oil inlet holes, such as a first oil inlet hole 712A and a second oil inlet hole 712B. The first oil inlet hole 712A is opposite to the second oil inlet hole 712B. The first oil inlet hole 712A and the second oil inlet hole 712B are communicated with the air passage 711. The e-liquid stored in the fluid tank 300 enters the air passage 711 through the first oil inlet hole 712A and the second oil inlet hole 712B. The embodiment of the present disclosure makes the e-liquid flow more smoothly.

The atomization core 720 is arranged in the air passage 711. The atomization core 710 is arranged along the transmission direction of the air passage 711, that is, the atomization core 710 is arranged along a vertical direction of the atomization device 20. The atomization core 710 is arranged along arranged along a direction of the top portion 320 of the atomization device 20 facing the bottom portion 310 of the fluid tank 300. The atomization core 720 is connected with the first thimble 410 and the second thimble 420 to connect to components such as the battery. The atomization core 720 generates heat after being energized, so as to atomize the e-liquid entering the air passage 711 from the first oil inlet hole 712A and the second oil inlet hole 712B. The atomization core 720 is made of ceramic material.

The top portion 320 of the fluid tank 300 may be equipped with a sealing structure to realize the sealing of the top portion 320 of the fluid tank 300. As shown in FIGS. 1-6, the atomization device 20 may further comprise a second sealing plug 600. The second sealing plug 600 is arranged on the top portion 320 of the fluid tank 300. The second sealing plug 600 is configured to seal the top portion 320 of the fluid tank 300. The second sealing plug 600 comprises a first air outlet hole 610;

The first air outlet hole 610 is communicated with the air passage 711. After the atomization core 720 is energized, the atomized gas formed by the atomization process is transmitted to the first air outlet hole 610 through the air passage 711. The atomized gas output from the first air outlet hole 610 can be smoked by the user.

As shown in FIGS. 1-6, the atomization device 20 further comprises a third cover plate 800. The third cover plate 800 is arranged on the second sealing plug 600. The third cover plated 800 covers the second sealing plug 600. The third cover plate 800 is used as a top cover of the atomization device 20, so that the second sealing plug 600 is arranged between the third cover 800 and the fluid tank 300. The third cover plate 800 comprises a second air outlet hole 810. The second air outlet hole 810 is communicated with the first air outlet hole 610. In some embodiments, the second air outlet hole 810 accommodates a portion of the second sealing plug 600.

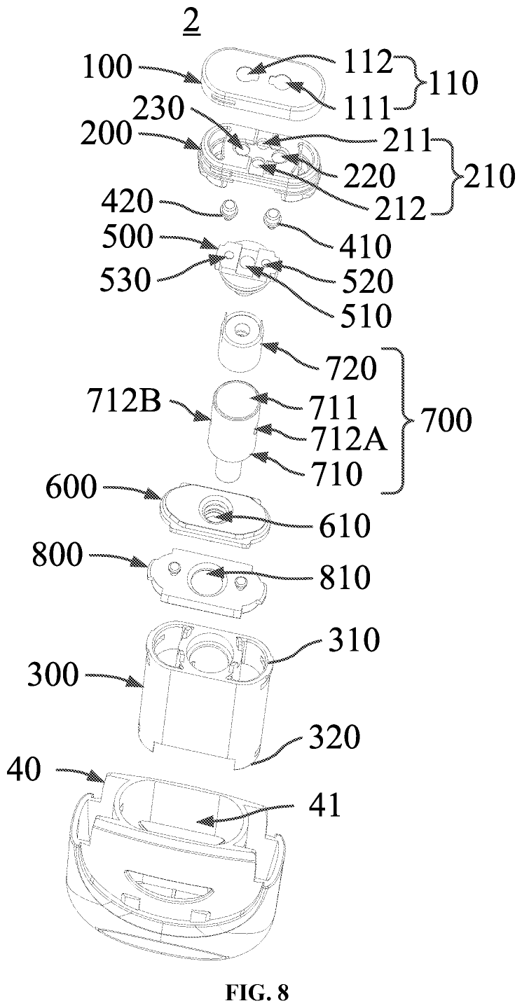

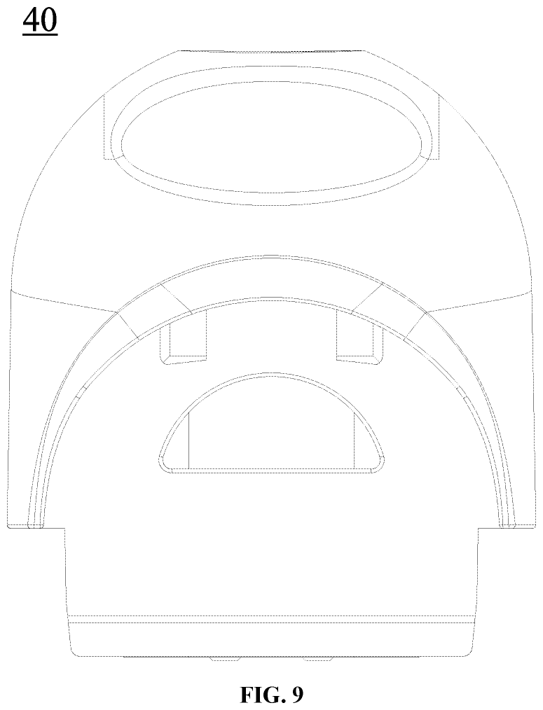

As shown in FIGS. 8 and 9, FIG. 8 is an exploded view of portions of an electronic cigarette according to one embodiment of the present disclosure and FIG. 9 is a schematic diagram of a cigarette holder of the electronic cigarette shown in FIG. 8. The electronic cigarette 2 comprises a cigarette holder 40, a first cover plate 100, a second cover plate 200, a fluid tank 300, a first thimble 410, a second thimble 420, a first sealing plug 500, a second sealing plug 600, and an atomization assembly 700. The first cover plate 100, the second cover plate 200, the fluid tank 300, the first thimble 410, the second thimble 420, the first sealing plug 500, the second sealing plug 600, and the atomization assembly 700 are same as that shown in FIGS. 1-7 and their related content, which are not repeated here.

A receiving cavity 41 of the cigarette holder 40 receives the first cover plate 100, the second cover plate 200, the fluid tank 300, the first thimble 410, the second thimble 420, the first sealing plug 500, the second sealing plug 600, and the atomization assembly 700, And a suction port (not shown in the figures) of the cigarette holder 40 is communicate with the first air outlet hole 610 of the second sealing plug 600. The user can smoke the atomized gas generated by the atomization assembly 700 through the suction port of the cigarette holder 40.

It should be noted that the electronic cigarette 2 may also comprise a third cover plate 800. The third cover 800 is same as that shown in FIGS. 1 to 7 and illustrated in related content, which will not be repeated here. The second air outlet hole 810 of the third cover plate 800 is connected to the suction port of the cigarette holder 40.

It is understood that the electronic cigarette 2 may also comprise other components, such as a battery not shown in the figures). The battery may be electrically connected to the atomization assembly 700 through the first thimble 410 and the second thimble 420, so as to provide power to the atomization assembly 700.

The atomization device and the electronic cigarette provided in the embodiments of the present disclosure are described in detail above. Specific embodiments are used in this article to illustrate the principles and implementation of the present disclosure. The descriptions of the above embodiments are only used to help understand methods and core ideas of the present disclosure. Meanwhile, for those skilled in the art, according to the idea of the present disclosure, there will be changes in the specific implementation and scope of present disclosure. In summary, the content of the specification should not be understood as limitations of the present disclosure

What is claimed is:

1. An atomization device, comprising:
a fluid tank;
an atomization assembly arranged in the fluid tank;
a first cover plate; and
a second cover plate;
wherein the first cover plate comprises at least two first air inlet holes, and the at least two first air inlet holes are arranged along a first direction; the second cover plate comprises at least two second air inlet holes, the at least two second air inlet holes are arranged along a second direction; the second cover plate is arranged on a bottom portion of the fluid tank; the second cover plate is connected with the first cover plate; the second cover plate is arranged between the fluid tank and the first cover plate;
wherein the first direction is different with the second direction; the at least two first air inlet holes are configured to transmit gas to the at least two second air inlet holes; the at least two second air inlet holes are configured to transmit the gas into the fluid tank.

2. The atomization device according to claim 1, wherein the at least two first air inlet holes comprise a first sub air inlet hole and a second sub air inlet hole; the at least two second air inlet holes are arranged between the first sub air inlet hole and the second sub air inlet hole.

3. The atomization device according to claim 2, wherein the second cover plate comprises a first mounting hole and a second mounting hole;
wherein the atomization device further comprises a first thimble connected with the atomization assembly and a second thimble connected with the atomization assembly;
wherein a portion of the first thimble is arranged in the first mounting hole; another portion of the first thimble is arranged in the first sub air inlet hole; a size of the first sub air inlet hole is greater than a size of the another portion of the first thimble arranged in the first sub air inlet hole;
wherein a portion of the second thimble is arranged in the second mounting hole; another portion of the second thimble is arranged in the second sub air inlet hole; a size of the second sub air inlet hole is greater than a size of the another portion of the second thimble arranged in the second sub air inlet hole.

4. The atomization device according to claim 3, wherein the atomization device further comprises a first sealing plug arranged on the bottom portion of the fluid tank and a second sealing plug arranged in a top portion of the fluid tank;
wherein the first sealing plug is configured to seal the bottom portion of the fluid tank, the first sealing plug is arranged between the fluid tank and the second cover plate; the first sealing plug comprises a third air inlet hole; the third air inlet hole is communicated with the at least two second air inlet holes;
wherein the second sealing plug is configured to seal the top portion of the fluid tank, the second sealing plug comprises a first air outlet hole;
wherein the atomization assembly comprises a vent pipe and an atomization core;
wherein the vent pipe comprises an air passage communicated with the first air outlet hole and the third air inlet hole; the atomization core is arranged in the vent pipe.

5. The atomization device according to claim 4, wherein the vent pipe comprises a plurality of oil inlet holes, the plurality of oil inlet holes are arranged oppositely.

6. The atomization device according to claim 4, wherein the atomization core is made of ceramic material.

7. The atomization device according to claim 4, wherein the atomization device further comprises a third cover plate; the third cover plate is arranged on the second sealing plug, the third cover plated covers the second sealing plug; the third cover plate comprises a second air outlet hole; the second air outlet hole is communicated with the first air outlet hole.

8. The atomization device according to claim 1, wherein an included angle between the first direction and the second direction is not less than 30 degrees and no more than 150 degrees.

9. The atomization device according to claim 8, wherein the included angle between the first direction and the second direction is not less than 60 degrees and no more than 120 degrees.

10. The atomization device according to claim 9, wherein the included angle between the first direction and the second direction is 90 degrees.

11. The atomization device according to claim 10, wherein the first direction is a width direction of the atomization device; the at least two first air inlet holes are arranged along the width direction of the atomization device, the second direction is a thickness direction of the atomization device; the at least two second air inlet holes are arranged along the thickness direction of the atomization device; and the width of the atomization device is greater than the thickness of the atomization device.

12. The atomization device according to claim 1, wherein the first direction is a width direction of the atomization device; the at least two first air inlet holes are arranged along the width direction of the atomization device.

13. The atomization device according to claim 1, wherein the second direction is a thickness direction of the atomization device; the at least two second air inlet holes are arranged along the thickness direction of the atomization device.

14. An electronic cigarette, comprising an atomization device; wherein the atomization device comprises:
a fluid tank;
an atomization assembly arranged in the fluid tank;
a first cover plate; and
a second cover plate;
wherein the first cover plate comprises at least two first air inlet holes, and the at least two first air inlet holes are arranged along a first direction; the second cover plate comprises at least two second air inlet holes, the at least two second air inlet holes are arranged along a second direction; the second cover plate is arranged on a bottom portion of the fluid tank; the second cover plate is connected with the first cover plate; the second cover plate is arranged between the fluid tank and the first cover plate;
wherein the first direction is different with the second direction; the at least two first air inlet holes are configured to transmit gas to the at least two second air inlet holes, and the at least two second air inlet holes are configured to transmit the gas into the fluid tank.
